(19) United States
(12) Patent Application Publication
(10) Pub. No.: US 2007/0233731 A1
(43) Pub. Date: Oct. 4, 2007

(54) System and method for configuring media systems

(75) Inventors: Glen McLean Harris, Auckland (NZ); Justin M. Henry, Mississauga (CA); Bryan McLeod, Schomberg (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/360,736

(22) Filed: Feb. 22, 2006

(51) Int. Cl. G06F 17/00

(52) U.S. Cl. 707/104.1

(57) ABSTRACT

A system and method for configuring a multi-component media system allows a user to specify a system and to obtain appropriate connection diagrams for the components, as well as a configuration dataset which can be loaded into a remote control to operate the resulting media system. Multiple connection diagrams can be provided, to allow the user to select the types of connection employed, and any additional cable or accessories required to effect the connection can be indicated. Preferably, the connection panels of the components are shown photographically in the connection diagrams to simplify the connection task.

### BACKGROUND

The present invention relates to a system and method for configuring a media system. More specifically, the present invention relates to a system and method for interconnecting, configuring and controlling a multi-component media system.

Media systems have become increasingly feature rich and complex in recent years. In particular, home theatre and state of the art audio systems now typically comprise multiple components, such as surround sound decoder/amplifier systems, sub woofers, display devices, DVD players, set top boxes, satellite receivers and/or satellite radio receivers, etc. and all of the myriad cables, links and remote control programming required to interconnect and operate them.

The complexity of these media systems has resulted in a significant problem for consumers, and thus for manufacturers and sales people, in the selection, interconnection, operation and maintenance of such systems. Many consumers are forced to seek expert advice from consultants who specialize in the assembly and configuration of such systems. For other consumers, consultation with salespeople is used to fill this roll, which can result in a less than optimal result to the consumer and/or which requires the salesperson to spend a great deal of time in making a sale.

This problem is further exacerbated when additional components are subsequently purchased and installed into an existing system. For example, a consumer with a home theatre system may wish to purchase a new DVD player with additional functionality and it can be difficult for that consumer to select a new DVD player that will interoperate, as desired, with the remainder of their existing system. For example, the new DVD player may offer an enhanced video output in a format which is not supported by the consumer's present display device. Further, when the consumer does purchase a new component, the consumer must also determine whether any additional cables will be required and/or the consumer must be confident that they can reprogram their remote control(s) to operate the device with the rest of their media system.

Consumer confusion and/or inability to get their purchased system or component connected and/or operating as expected leads to returns of merchandise, telephone calls to manufacturer's technical support services and general dissatisfaction with the purchase. Indeed, in some circumstances fear of connection and configuration difficulties can prevent a consumer from making a purchase altogether.

The assignee of the present invention operates a system for programming remote control devices to operate media systems wherein the user informs the system, via a web page interface, of the devices they wish to control and the system assembles a configuration data set comprising the necessary infrared control signals and associated commands and programs which is then downloaded, through the Internet, into the remote control to configure it to operate the media system. While this system for programming remote control devices is a significant advance over the prior art, it does not assist a user in purchasing and connecting components in a media system.

### SUMMARY OF SELECT EMBODIMENTS

It is an object of the present invention to provide a novel system and method for configuring media systems which obviates or mitigates at least one disadvantage of the prior art.

According to a first aspect of the present invention, there is provided a system for configuring a multi-component media system, comprising: a processor operable to execute a configuration process; a database operable to store information regarding media system components and to provide the stored information to the processor; an input device to receive input from a user and provide the input to the processor as part of the configuration process, the input comprising the specification of at least two media system components and a desired configuration activity; and an output device to provide output from the processorto the user to allow the user to interact with the configuration process, wherein the user can specify to the system the components of the media system of the user and the system will provide to the user the information necessary to connect the at least two components.

According to another aspect of the present invention, there is provided a method of configuring a media system comprising at least two media components, comprising the steps of: (i) identifying the components of the media system; (ii) determining at least one configuration to interconnect the at least two components; and (iii) providing a connection instruction set indicating the at least one configuration.

The present invention provides a system and method for configuring a multi-component media system. The invention allows a user to specify a system and to obtain appropriate connection instruction sets, preferably including connection diagrams, for the components, as well as a configuration dataset which can be loaded into a remote control to operate the resulting media system. Multiple connection instruction sets can be provided, to allow the user to select the types of connection employed, and any additional cable or accessories required to effect the connection can be indicated. Preferably, the connection panels of the components are shown photographically in the connection diagrams to simplify the connection task.

### BRIEF DESCRIPTION OF THE DRAWINGS

Preferred embodiments of the present invention will now be described, by way of example only, with reference to the attached Figures, wherein:

FIG. 1 shows a schematic representation of a system in accordance with the present invention; and

FIGS. 2a, 2b, 2c and 2d show a flowchart of a method in accordance with the present invention.

### DETAILED DESCRIPTION

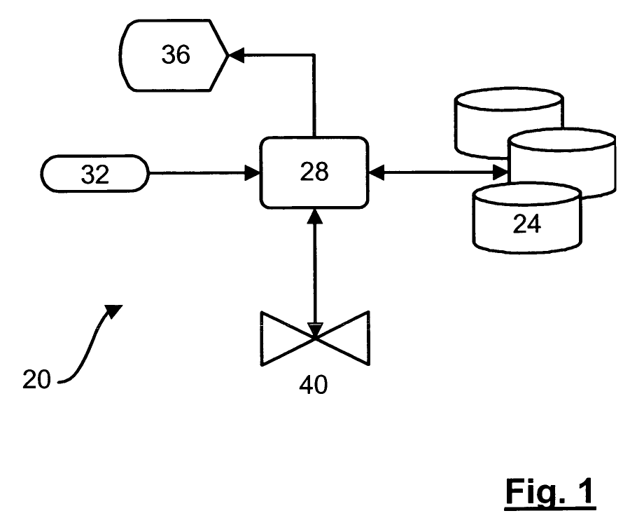

A system for configuring media systems is indicated generally at 20 in FIG. 1. System 20 comprises a database 24, a processor 28, an input device 32, an output device 36 and an input/output communication port 40. Database 24 can be any suitable database system, such as one or more MySQL or Oracle database engines combined with suitable storage devices such as a Winchester disk drive and/or read only storage devices such as CD ROMs or DVD ROMs. Database 24 is operable to store a variety of information regarding components for media systems and, preferably, to persist information regarding users of system 20 and their media systems. Database 24 need not be a RDBM system, although this is presently preferred, but can instead be any suitable system for storing information.

Processor 28 can be any suitable computing device such as a general purpose computer like a personal computer, or a special purpose computing device such as a satellite or cable TV set-top box. Depending upon the complexity of the computing tasks effected by processor 28, as described below, it is contemplated that processor 28 can comprise a distributed system of computing devices. For example, processor 28 can comprise a set-top box which processes user interface tasks from input 32 and to display 36 and the operation of communication port 36, and processor 28 can further comprise a general purpose computing system on which database 24 resides and is executed. In such as case, a suitable communication link, such as a TCP/IP data link over the Internet or a private network, will be employed between the various components of processor 28.

Input device 32, which is operably connected to processor 28, can comprise any suitable user interface input device. Examples of such user interface input devices include conventional keyboards, touch panels, remote controls for set-top boxes, bar code scanners, kiosk systems, etc. As described below, a user interacts with system 20 via input device 32 to provide a variety of information to system 20, to select between various options offered by system 20 and/or to initiate programming of external devices by system 20.

Display 36, which is operably connected to processor 28, can comprise any suitable method for conducting a user interface session with a user of system 20. Display 36 can comprise a CRT or LCD computer monitor, the display portion of a touch panel device, a television when system 20 includes a set-top box or the like, etc.

Input/output communication port 40, which is also operably connected to processor 28, can comprise any suitable communications port which can be used to effect programming of another device, such as an infrared and/or RF remote control, and/or to receive data from another device, such as log data from the previously mentioned remote control. Input/output communication port 40 can comprise a USB port, a Firewire port, an RF-based communications port such as an 802.11x or Bluetooth transceiver, a proprietary I/O port, etc.

It is contemplated that system 20 can be implemented in a wide variety of manners. For example, system 20 can be Internet-based using both the user's personal computer and computing devices/services offered by a service provider. In such a case, database 24 can be operated and maintained remotely by the service provider and processor 28 can comprise a processing system operated by the service provider as well as the user's personal computer which connects to the service provider's processor via a communication link, such as the Internet. In a preferred embodiment, the user executes a web browser on their personal computer which connects to a web server executing on the processor operated by the service provider. The web server provides a graphical user interface and communication manager allowing the display of the user's personal computer to serve as display 36, the keyboard and/or mouse of the user's personal display to serve as input device 32 and a USB, Firewire or other port of the user's personal computer to serve as input/output communication port 40.

As another example, it is contemplated that the contents of database 24 and copies of suitable control and user interface programs can be provided to a user on a storage medium, such as a CD ROM or DVD ROM, or be made available as a download over the internet, for loading and execution on the user's personal computer. In such a case, all of the components of system 20 will be components and/or processes executing on the user's personal computer system. It is further contemplated that, if the user's personal computer is connected to the Internet, updates and/or additions to the information in database 24 stored on the storage medium or downloaded data can be provided to the user over the Internet. It is also contemplated that, in the case of an Internet connected computer, the storage medium can omit the contents of database 24 and these are accessed, as needed, over the Internet from database 24 provided by a service provider.

As yet another example, system 20 can be implemented in a dedicated sales kiosk in a store, the kiosk preferably having Internet access. In this case, database 24 can include additional information, such as a catalog of media system components and accessories sold by the store for use as further discussed below.

As is described below, system 20 operates to assist a user to select, connect and configure a media system. If the user already has purchased a media system, system 20 can assist the user in interconnecting the various components of the media system and in configuring a remote control to appropriately operate those components. If the user is interested in acquiring a media system comprising several components, system 20 can assist in selecting, connecting and configuring such a system for purchase. Also, if the user is interested in adding one or more components to an existing media system and/or replacing one or more components in an existing media system, system 20 can also assist the user in selecting, connecting and configuring the new component and the resulting media system.

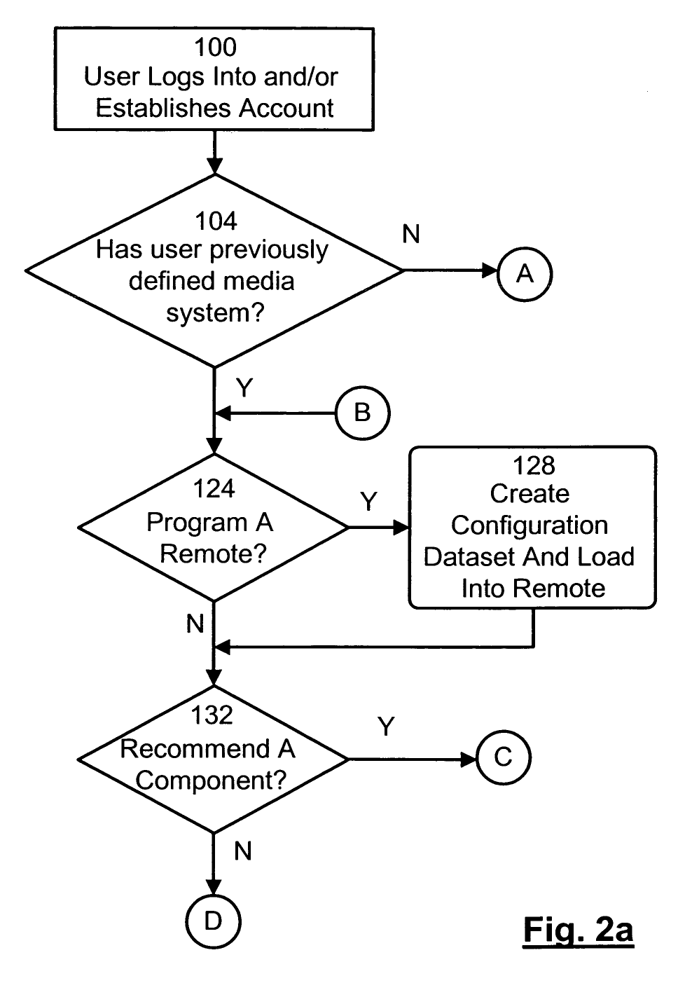

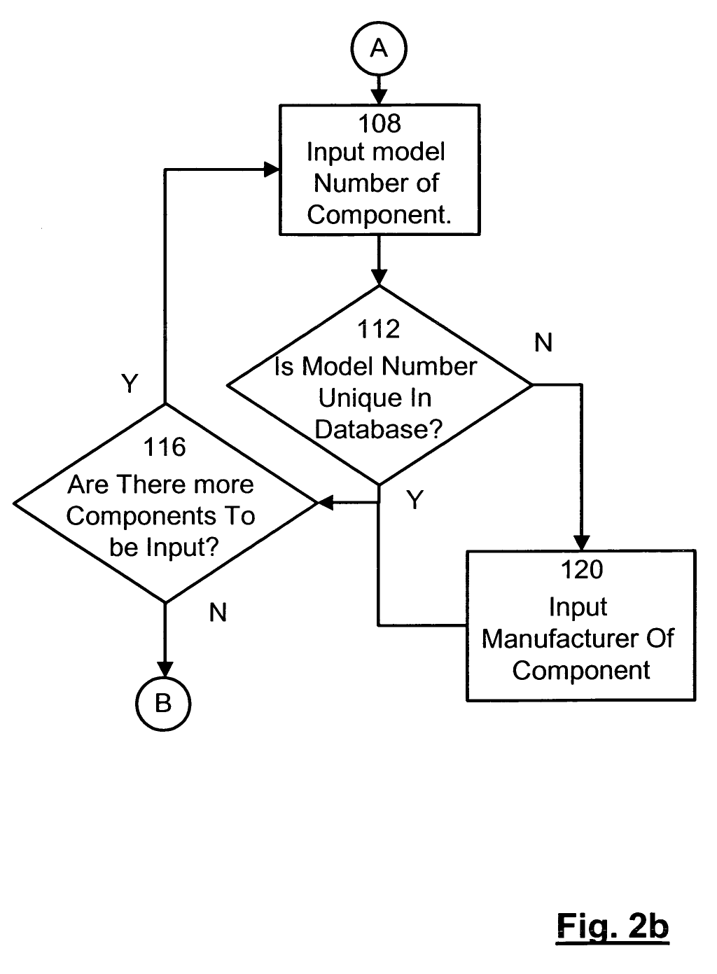

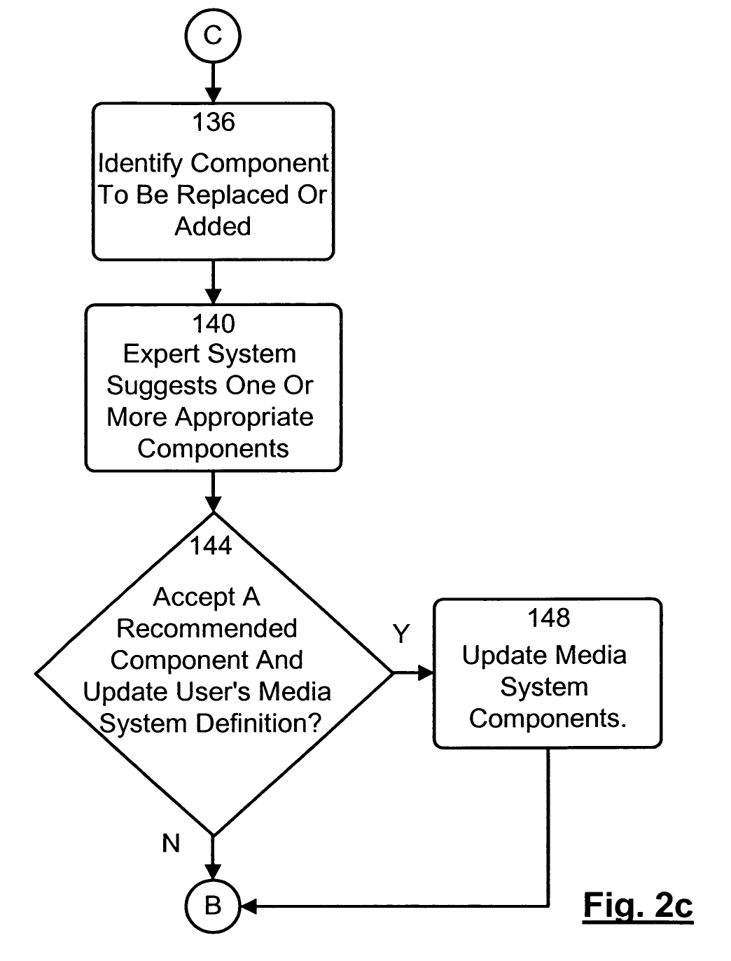

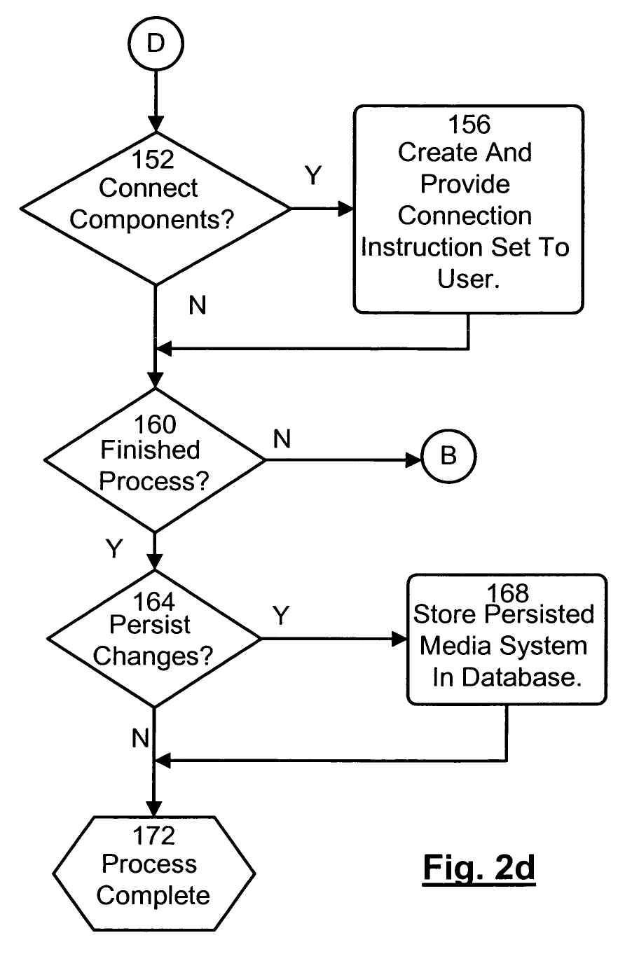

FIGS. 2a, 2b, 2c and 2d show a flowchart representing the steps involved in a method in accordance with the present invention and performed in conjunction with system 20 described above.

As shown, the method commences at step 100 wherein a user logs in to system 20. When system 20 is installed on the user's personal computer, the login step can be accomplished by starting execution of system 20.

If system 20 is web-based, or has at least part of database 24 stored at a remote location, it is preferred that the login process comprise the establishment of an account for the user, the first time the user implements the method, and the login to that account by the user. By creating and maintaining an account for a user, a variety of useful information relating to the user can be persisted in database 24 or elsewhere. The process of establishing and logging into a user-specific account is well known to those of skill in the art and will not be described in further detail herein.

Once the user has logged in, the method continues at step 104 where a determination is made as to whether the user has already defined the make up of their media system within their account, or whether the user needs to do so. If the user has not previously defined a media system within their account, the method continues at step 108 wherein the user is prompted to define each component of a media system.

Specifically, at step 108 the user is prompted to input the model number of a first component, such as an A/V receiver. Preferably, the input process is designed to be as efficient as possible by first asking for the model number of the component, rather than the manufacturer of the component. Alternatively, if input device 32 of system 20 includes a bar code scanner, the component can be identified by scanning the bar code on the packaging for the component. It is contemplated that this process may be more useful when the user is at a store and is performing the method at system 20 in a kiosk or other computing station in the store.

At step 112, the method determines if the input model number uniquely identifies a component in database 24. If the input model number does uniquely identify a component in database 24, then at step 116 the method determines if there are more components to be identified, typically by prompting the user with this question, although it is also contemplated that the method can make its own determination in some cases, such as when a DVD player has previously been identified as a component and no television has yet been identified. In the case of this example, step 116 can comprise determining that a television set likely needs to be identified.

If, at step 112, it is determined that the model number does not uniquely identify a component in database 24, then the method continues at step 120 where the user is asked to input the manufacturer of the component or select the appropriate component from the list of components in database 24 which are identified by that model number, after which the component has been identified and the method continues at step 116.

The method of steps 108, 112, 116 and 120 will typically be performed by the user for the media system components that they presently own. However, it is also contemplated, as will be further described below, that the user can input one or more components which they are merely contemplating purchasing.

As will be apparent to those of skill in the art, in some circumstances database 24 may not contain an entry for a component input by the user. In such a case, provided that the user owns the component, any suitable method for having the user provide the necessary data for the component to database 24 can be employed, as will be apparent to those of skill in the art. In a presently preferred embodiment of the invention, the user is guided through a set of input gathering web pages and may be prompted to provide infrared commands from the remote control which was supplied with the component.

A good example of such a preferred method for obtaining the necessary data for a component is employed on the web pages operated by the assignee of the present invention for its Harmony brand of remote controls and will not be further described herein.

If the user has input a component which is not in database 24 and which the user is contemplating purchasing, the system will inform the user that it does not have the necessary information for that component and will remove that component from the user's account and suggest that the user input an alternative component.

Steps 108, 112, 116 and 120 are performed, as necessary until the components of the user's media system, or proposed media system, have been input.

Once the user has defined a media system, the method proceeds to ask the user what they would like to accomplish. At step 124, the user is asked of they want to program a remote control to operate the media system they have defined.

If the user indicates that they do wish to program a remote control, at step 128 processor 28 and database 24 execute a configuration process to create a configuration dataset which can be downloaded, via input output communication port 40, into the user's remote control (which was one of the components of the media system defined by the user). Preferably, the user's remote control employs the Smart State technology of the Harmony brand remotes sold by the assignee of the present invention, in which case the necessary infrared and/or RF signals for the remote to control the media system components are downloaded into the remote, as is the necessary state change information to place the media system into the necessary state for a desired activity, such as watching a DVD, and to change the media system between necessary states for different activities. An embodiment of the Smart State remote control technology is described in U.S. Pat. No. 6,784,805 to Harris et al. and assigned to the assignee of the present invention and the contents of this patent are incorporated herein by reference.

Once step 128 has completed, or if the user has responded negatively at step 124, at step 132 the user is asked if they are interested in obtaining a recommendation of one or more components to be added or updated in their media system. If the user responds positively, at step 136 the method directs the user to identify the existing component of the media system which the user wishes to replace or the component which the user wishes to add to their media system.

Once the particular component, or category of component, has been input, at step 140 the method invokes an Expert system to identify one or more suitable components. The implementation of the Expert System is not particularly limited and can be accomplished in a wide variety of manners, as will be understood by those of skill in the art. The Expert System will employ data related to media system components which is stored in database 24 and will also consider the components of the user's media system, previously defined by the user.

Preferably, the Expert System will allow the user to select and/or sort alternatives by a variety of criteria, including price ranges, manufacturers and/or desired features. For example, a user seeking to update their AN receiver can specify to the Expert System that they are interested in receivers manufactured by SONY, which include both Dolby and THX sound processors and which are under $1,000 in price.

If the method of the present invention is implemented via an in store kiosk, or via a vendor's web page, the Expert System can also consider factors such as whether a particular component is presently in stock, whether a component is on sale and/or if the vendor has favorable pricing for packages of components that might also be of interest to the user and will provide this information to the user along with the recommendations of particular components.

It is also contemplated that the user can be asked if they wish system 20 to review their entire media system and recommend any suggested updates and/or upgrades. If the user responds positively, the method will look at the user's entire media system and will make appropriate recommendations of components that might be upgraded or added to the system and/or different connection strategies (and any necessary cables or accessories to effect them).

At step 144 the user is asked if they wish to select one of the recommended components and to update their media system to include the selected component. If the user selects one of the suggested components, at step 148 the definitions of the components of the media system are updated appropriately. If at step 144, the user decides to not select a suggested component, or when step 148 is complete, the method returns to step 124 where the user is offered the choice of reprogramming their remote to operate their media system with the newly added component, if the user has added a new component at step 148.

At step 152, the user is asked if they wish to be provided with a connection instruction set. If the user responds positively, at step 156 a connection instruction set is created for the components of the user's media system. The connection instruction set will, at a minimum, include written instructions on how the various components of the user's media system are to be interconnected. Preferably, the connection instruction set includes one or more connection diagrams which can comprise a series of graphical representations of the connection panels of the components of the user's media system with the appropriate connections between the components being illustrated as well. However, in a most preferred embodiment of the present invention, photographic representations of the connection panels of the components of the media system are shown with the connections overlaid on the photographs to further simplify the making of the connections by the user. It is contemplated that these photographic representations can be provided to the operator of system 20 by the manufacturer of the components, as this will both increase the likelihood that a user will purchase the component in question, as they are confident that they can connect it properly, and will decrease the likelihood that the user will find it necessary to contact product support services offered by the component manufacturer. It is contemplated that the resulting connection instruction sets can be output from a printer and/or can be available to the user via a web browser interface to system 20.

In addition to creating a single connection instruction set at step 156, the method can provide two or more different connection instruction sets indicating, for example, “Economy”, “Better” and “Best” connection strategies for the user's media system. For example, an “Economy” connection strategy may transfer video signals via a composite video cable and audio signals via patch cords, while a “Better” connection strategy may employ S-video cables to transfer video and a coaxial cable to transfer audio while a “Best” configuration strategy may employ component video cables to transfer video signals and an optical cable to transfer audio signals. It is contemplated that the connection instruction sets will also indicate to the user any additional accessories which will need to be purchased to effect the desired connection, such as the optical cables for audio transfer, connection adapters, etc.

Once the connection instruction sets have been provided to the user at step 156, the method continues at step 160 wherein the user is asked if they are finished. If the user indicates that they are finished, the process completes at step 164 where they are asked if they want system 20 to store the definition of their media system.

If the user does wish to the store the definition of their media system at step 168 all the relevant information for the user's media system is stored in database 24. At step 172 the process completes and the user is logged out of system 20.

By allowing a user to change their media system without saving the changes, the user can perform “what if” types of analysis with their media system to evaluate the addition of different components and/or configurations for their media system.

If at step 156 the user indicates that they are not finished, the method returns to the point of step 124.

It is contemplated that system 20 and the method described herein with reference to FIGS. 2a through 2d provide numerous advantages. For example, by persisting the definition of the user's media system, a user visiting a store and considering the purchase of a new component, to add to their system or to replace an existing component in their system., can easily and conveniently check that the new component is compatible with their existing system (i.e.—if a new DVD player under consideration only offers component video output and the user's TV does not has component vide inputs, they the new DVD player is not compatible).

Further, the user can easily use the Expert System of step 140 to obtain suggestions and/or recommendations for the new component. Should the user purchase the new component and update and store the definition of their media system, they can easily obtain a connection instruction set indicating the ways in which the new component can be connected in their system and indicating any cables or other accessories which may be required to connect the component. Also, when the user has the new component connected, they can reprogram their remote control to correctly operate the resulting system by accessing system 20 again to download an appropriate configuration data set into their remote.

As will be also apparent, by persisting information regarding a user and their preferences, the interaction of the user with system 20 can be iterative. For example, the user can access system 20 at a store to have system 20 recommend a DVD player which the user purchases. The user can also obtain recommendations of accessories (cables, etc.) recommended to connect the new DVD player and can purchase those too. When the user gets home with their new purchases, they can again access system 20 to obtain connection instruction sets for their new purchases and/or to program or reprogram their remote control, etc.

It is also contemplated that system 20 can allow people other than the user to access the definitions of the user's media system and use portions of the method of the present invention. For example, a wife wishing to buy a media component as a gift for her husband can access system 20 to access the Expert System of step 140 to determine a suitable component to purchase and can access the connection instruction sets of step 156 to determine what cables and/or other accessories may be required to appropriately connect the new component. However, it is also contemplated that while others may be able to access the stored definitions of a user's media system, only the user will be able to alter those stored definitions.

As is mentioned above, it is also contemplated that the method of the present invention and system 20 can be implemented in a variety of manners including on the user's Internet connected personal computer, via a set top box which is part of the media system, via a sales and information kiosk provided at a store, etc. In the case of the kiosk implementation, or a web site accessed from the user's personal computer, the vendor offering the kiosk or web site can have the Expert System of step 140 consider their present inventory when making a recommendation and/or can favor the components of one or more manufacturer.

The present invention provides a system and method for configuring a multi-component media system. The invention allows a user to specify a system and to obtain appropriate connection instruction sets for the components, as well as a configuration dataset which can be loaded into a remote control to operate the resulting media system. Multiple connection instruction sets can be provided, to allow the user to select the types of connection employed, and any additional cable or accessories required to effect the connection can be indicated. Preferably, the connection panels of the components are shown photographically in connection diagrams in the connection instruction sets to simplify the connection task. The system can also include an Expert System which can suggest additional components for use in the media system

The above-described embodiments of the invention are intended to be examples of the present invention and alterations and modifications may be effected thereto, by those of skill in the art, without departing from the scope of the invention which is defined solely by the claims appended hereto.

What is claimed is:

1. A system for configuring a multi-component media system, comprising:
a processor operable to execute a configuration process;
a database operable to store information regarding media system components and to provide the stored information to the processor;
an input device to receive input from a user and provide the input to the processor as part of the configuration process, the input comprising the specification of at least two media system components and a desired configuration activity; and
an output device to provide output from the processor to the user to allow the user to interact with the configuration process, wherein the user can specify to the system the components of the media system of the user and the system will provide to the user the information necessary to connect the at least two components.

2. The system of claim 1 further including an input/output communication port wherein the system can, via the communication port, program a remote control to correctly operate the media system.

3. The system of claim 1 wherein the specification of the at least two media system components by the user is persisted in the database.

4. The system of claim 1 further comprising an Expert System and wherein the system is further operable to suggest, at the request of the user, one or more media system components to be added to the media system.

5. The system of claim 1 wherein the information necessary to connect the at least two components is provided to the user in the form of a connection instruction set.

6. The system of claim 5 wherein the connection instruction set includes a connection diagram.

7. The system of claim 6 wherein the connection diagram includes a photograph of the connections of at least one of the media system components.

8. The system of claim 1 wherein the information necessary to connect the at least two components provided to the user includes a list of additional cables and accessories required.

9. A method of configuring a media system comprising at least two media components, comprising the steps of:
(i) identifying the components of the media system;
(ii) determining at least one configuration to interconnect the at least two components; and
(iii) providing a connection instruction set to achieve the at least one configuration.

10. The method of claim 9 wherein step (ii) comprises the step of determining at least two configurations to interconnect the at least two components, each configuration utilizing at least one different connection on the at least two components and wherein step (iii) comprises providing each of the determined configurations as a separate configuration instruction set.

11. The method of claim 9 wherein the connection instructions include a connection diagram.

12. The method of claim 11 wherein the connection diagram includes a photograph of the connections of at least one of the components.

13. The method of claim 9 further comprising the step of indicating any cables or accessories required by a configuration.

14. The method of claim 9 further comprising the steps of creating a configuration dataset to program a remote control to operate the configuration of the at least two components and loading the configuration dataset into a remote control.

15. The method of claim 9 wherein the identified components are persisted in a database.

16. The method of claim 15 further comprising the steps of receiving input from a user indicating a desire to add at least one component to the media system and utilizing an Expert System to suggest one or more components which are appropriate for the identified components and for any additional criteria provided by the user.
